(19) United States
(12) Patent Application Publication
(10) Pub. No.: US 2022/0207571 A1
(43) Pub. Date: Jun. 30, 2022

(54) Media Content Made Interactive With Triggers "Saving" Associated Content For Later Engagement

(71) Applicant: Joseph David Martin, London (GB)

(72) Inventor: Joseph David Martin, London (GB)

(21) Appl. No.: 17/567,009

(22) Filed: Dec. 31, 2021

Related U.S. Application Data
(60) Provisional application No. 63/132,808, filed on Dec. 31, 2020.

(51) Int. Cl. G06Q 30/02; H04W 4/35; G06V 20/20

(52) U.S. Cl. CPC G06Q 30/0276; G06V 20/20; H04W 4/35

(57) ABSTRACT

The current disclosure relates to Software Development Kit technology for deep embedding of retrievable brand content in third party audio and visual platforms, advertising units, or publisher content only accessible once triggered by the actions of an end user. The retrievable brand content is delivered by a cloud-based database, the Tickle™ cloud. The Tickle™ cloud stores all of the brand content to be triggered by specific actions. The Tickle™ technology automatically finds and matches saved content to other existing content readily available online. The brand content has a set of rules attached to it which will enable the right content to be delivered to the correct end user. Content is retrievable by the consumer for further engagement using a mobile and/or smartphone application and an online web-browser extension/plug-in. The Application enables consumer interaction with embedded brand content across all electronic media formats and print media.

### CLAIM TO PRIORITY

This application claims under 35 U.S.C. § 120, the benefit of the Provisional Application 63/132,808, filed Dec. 31,2020, titled “Software Development Kit for Embedding Deep Content in All Media Formats Triggering Targeted Offers to be Distributed, Redeemed and Managed by the Target Consumer Through One Centralized Cloud Platform” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

With over 86 million internet-using consumers now using ad blockers in the US alone a better way for brands to communicate with consumers on a deeper level should be found.

Recent developments in IDFA and GDPR regulations and the decision to remove cookies from the internet mean that it will now be even harder to provide the right content to the right consumers who do not want to block advertising altogether. These clients just wish brand communication of content was better realized. Continual progression toward tighter restrictions around privacy is welcomed, however, such progression may at the same time bring the advertising industry to its knees. This may mean that the resulting desperation from advertising industry in the face of increased difficulty in publishing content to consumers could lead to further abuse of consumer information and trust.

Brands need to speak to their customers and sell their products to thrive, publishers advertise brands to their own consumers in return for money that they need to be successful publishers and consumers want to discover new brands and products as well as keep up to date with the latest trends and ranges from their favorite brands. However, monetization and competition for consumer attention has driven advertising into a dark place where results are often fabricated or inaccurate, publishers lose customers by forcing them to watch interruptive advertisements, and consumers are now subconsciously trained to ignore the 5,000-10,000 ads that are put in front of us each and every day. This is a failing model that needs to change.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the centralized platform and SDK for all ad channels on Tickle™ Wallet consistent with certain embodiments of the present invention.

FIG. 2 is a view of a state diagram for the Tickle™+SDK for mobile publishers, existing ad units, and Tickle™ proprietary ad units consistent with certain embodiments of the present invention.

FIG. 3 is a view of an SDK for embedding deep content in publisher content consistent with certain embodiments of the present invention.

FIG. 4 is a view of a state diagram for the Tickle™+SDK for the delivery of IntARactive™ billboards on map-based apps and websites consistent with certain embodiments of the present invention.

FIG. 5 is a view of the SDK for embedding in-world digital billboards within publisher maps and digital worlds consistent with certain embodiments of the present invention.

FIG. 6 is a view of embedding encrypted sound technology in broadcast media consistent with certain embodiments of the present invention.

FIG. 7 is a view of an SDK for embedding brand content within broadcaster content consistent with certain embodiments of the present invention.

FIG. 8 is a view of the use of iBeacon and/or Bluetooth technology to activate and deactivate a consumer's device consistent with certain embodiments of the present invention.

FIG. 9 is a view of an SDK for embedding brand content within broadcaster content with automatic delivery to user handset consistent with certain embodiments of the present invention.

FIG. 10 is a view of the programmatic real-time exchange for the delivery of brand advertising and content through adSound™ technology consistent with certain embodiments of the present invention.

FIG. 11 is a view of programmatic real-time buying for delivering targeted publisher contend using encrypted sound technology to trigger targeted brand content delivery consistent with certain embodiments of the present invention.

FIG. 12 is a view of a state diagram showing browser extension for Tickle™ Wallet in a browser consistent with certain embodiments of the present invention.

FIG. 13 is a view of the delivery of brand content from interactions within a virtual world for engagement and redemption by an end user consistent with certain embodiments of the present invention.

FIG. 14 is a view of connection of the Tickle™ SDK and a gaming console medium for the delivery of brand content to a user consistent with certain embodiments of the present invention.

FIG. 15 is a view of the publication of game publisher generated brand content within a game consistent with certain embodiments of the present invention.

FIG. 16 is a view of generation of an advertising campaign into an Tickle™ domain consistent with certain embodiments of the present invention.

FIG. 17 shows the centralized consent management module where consumer opt-in happens in the Tickle™ app, enabling Tickle™ to collect data and serve content to the consumer in a third-party environment consistent with certain embodiments of the present invention.

FIG. 18 is a first view of a user experience involving direct purchase of items consistent with certain embodiments of the present invention.

FIG. 19 is a second view of a user experience involving direct purchase of items consistent with certain embodiments of the present invention.

FIG. 20 is a third view of a user experience involving direct purchase of items consistent with certain embodiments of the present invention.

FIG. 21 is a process view of a sub-process involving direct purchase of items from ad units consistent with certain embodiments of the present invention.

FIG. 22 is a reveal mechanic used as an identifier to the consumer to show that the consumer can engage further with the content consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

### Definitions:

“Application” shall refer to software that allows a user to perform specific tasks. Applications for desktop or laptop computers are sometimes called desktop applications, while those for mobile devices are called mobile apps. When a user opens an application, it runs inside the operating system of the computer or mobile device until the user closes it.
“Application store” and “App Store” shall refer to an online store for purchasing and downloading software applications and mobile apps for computers and devices.
“Application User” and “User” shall refer to any end-user of the computer application and/or mobile application innovation described herein.
“Augmented Reality” shall refer to a technology that superimposes a computer-generated image on a user's view of the real world, thus providing a composite view.
“Brand Console” shall refer to a front-end computer interface designed specifically for publishers and merchants to input and setup campaigns for products and services.
“Brand content” or “Content” refers to any content that is published across any media format including offers, rewards, vouchers, coupons, audio and visual content and experiences, additional information and purchasing/ecommerce mechanics.
“Broadcast Media” includes any media that is broadcasted or streamed across any electronic device including television, radio, voice, animation, cinema and video and audio streaming services such as Netflix, YouTube, Spotify and Apple Music.
“Broadcast Medium” refers to any hardware that streams, plays or broadcasts visual and/or audio communications including but not limited to; Televisions, Mobile devices, games consoles, projectors, billboards, Radios, smart speakers and connected devices.
“Cloud” shall refer to servers that are accessed over the internet and the software and databases that run those servers. For the purposes of this document, it shall also refer to any and all computer storage or management systems that also use physical databases and manually run software or Edge computing or any future variation of data storage and transfer.
“Computational Logic” shall refer to the use of logic to perform or reason about computation, or “logic programming.” A program written in a logic programming language is a set of sentences in logical form, expressing facts and rules within a specified domain.
“Digital Billboard” shall refer to any visual presentation of display content for the purposes of advertising or transfer of visual and/or audio content.
“Genetic Algorithm” shall refer to a metaheuristic artificial intelligence programming technique wherein computer programs are encoded as to mimic a set of genes that is then modified (evolved) using an evolutionary algorithm. It is an automated method for creating a working computer program from a high-level problem statement. Genetic programming starts from a high-level statement of “what needs to be done” and automatically creates a computer program to solve the problem. The result is a computer program capable of performing well in a predefined task.
“In-World” shall refer to any digital representation of this world or any other where a consumer engages with a digital interface to view publisher content presented within it. Such digital representation includes but is not limited to that available through streamed media, augmented reality, virtual reality and mixed reality worlds, mobile, online and console games.
“Non-Targeted” shall refer to brand content that is published and/or broadcasted to an end user without the use of data to match the content to the user based on preference data.
“Map” shall refer to a digital map interface in real-world or fictional world format.
“Over the air” shall refer to any transfer of data that is not connected by a physical source, this includes but is not limited to WiFi, Bluetooth, Radio waves and Digital Frequency.
“Publisher” shall refer to any platform or software owner who publishes and/or broadcasts content.
“Save” and/or “Saving” shall refer to the act of engaging with publisher content in the publisher environment that from a user experience feels as though the user is saving the advert or content for later but the technical mechanic actually uses the action of ‘saving’ to trigger associated content. By way of non-limiting example, once the content is swiped or clicked in the publisher environment an offer related to the content is delivered to the user in the Tickle™ app.
“SDK” shall refer to a Software Development Kit which is typically a set of software development tools that allows the creation of applications for a certain software package, software framework, hardware platform, computer system, video game console, operating system, or similar development platform.
“SSP” shall refer to Supply Side Platform of the instant innovation.
“Targeted” shall refer to the use of technology to deliver brand content to an end-user based on information held on that user. This information held on the user includes but is not limited to partners preferences, favorite brands, previous engagement or buying behaviors, sex, age, demographic and location data.
“Tickle™ Save Mechanic” shall refer to the mechanic or mechanics made available through the Tickle technology that enables a user to trigger the “save/saving” action. By way of non-limiting example, in mobile this may involve a click or swipe action, with images derived from Out-of-Home (OOH) and/or Digital-Out-of-Home (DOOH) and/or Print advertising. This action may include using the user's camera view functionality on the user's mobile phone/device to scan and ‘save’ the image. Audio and/or visual media may be processed through proprietary audio technology, with the resulting product being embedded and played through the content. In any event, the user may be prompted by the user mobile device to ‘save’ the proffered content.
“Virtual Offer” shall refer to any data object that represents a virtual offer and is provided into an augmented reality environment by a publisher.

### Referenced Terms:

Reference throughout this document to the Tickle™ Browser extension and auto-completion refers to the Tickle™ application that will be active in the browser via an extension and provides auto complete codes and discounts for the User presenting offers, discounts and rewards.

Reference throughout this document to Tickle™+RTB refers to the creation and execution of programmatic delivery of brand content including display content, audio, video and Augmented Reality ad units over 5G and future over-the air-technologies.

Reference throughout this document to Tickle™+SDK refers to the creation and utilization of an SDK that enables new and existing mobile ad units to deliver real-world offers to one centralized platform for further engagement, management and redemption while keeping the user in the publisher's app and refreshing the ad content where applicable.

Reference throughout this document to adSound™ refers to the use of sound technology to trigger an over the air ‘real world’ interaction with the user's mobile wallet to automatically deliver an offer from a media device such as a tv, speaker or Digital Out of Home (DOOH) and/or Out of Home (OOH) advertising unit.

Reference throughout this document to adsound™ RTB refers to the creation and execution of programmatic RTB for broadcast using the opt-in/available data from the Tickle™ servers to deliver targeted ad units to the audience in the immediate vicinity across all content mediums.

Reference throughout this document to IntARactive™ refers to a proprietary class of new of advertising units specifically for smartphone and applications that use maps as part of their product, as a part of which application the Tickle™ SDK will trigger a digital billboard that will appear on the map.

The Tickle™ platform technology makes publisher content across all media formats interactive so that a user can take an action that triggers the release and delivery of additional associated content from any media format that can then be engaged with on a different centralized platform while keeping the user in the original publisher environment.

The Tickle™ platform, apps, mechanics and technology enable consumers to save adverts and publisher content for later into a mobile and/or online wallet (cloud) with one simple action that then triggers further content to the user.

Tickle™ mobile and online application; users are exposed to an advert, offer, or content that has a unique identifier that shows to the consumer that they can engage further with the advert in order to save it for later and/or unlock further offers, rewards and/or content in the Tickle™ app. Swiping, tapping or clicking on the advert (the action) triggers the Tickle™ technology mechanic to save that content in the Tickle™ app while leaving the consumer in the publisher environment where the initial advert/offer/content was first presented. The technology can then deliver a second/third/fourth etc advert/offer/content in the same place as the initial content allowing the consumer to also save that advert/offer/content for later as well.

Tickle™ audio technology is used to create the same mechanic for any audio and/or visual media where the inaudible audio frequency can connect with the consumers mobile device and deliver them and advert/offer/content for the consumer to then decide if they want to keep.

All content that is delivered to the Tickle™ app/wallet/cloud can then be matched to further offers/rewards/content using the Tickle™ Technology Stack and the consumer can then engage further with the matched content to improve the offer/reward and redeem what they have unlocked in the real world either physically or digitally.

The Tickle™ SDK and supporting mobile application elevates the entire advertising and brand content ecosystem by allowing consumers to unlock and engage with a deeper level of content from the ads they see around them every day. Imagine being able to point your smartphone at a billboard advertising your favorite brand and automatically receive a message or other communication providing the consumer with 50% off the product being advertised right to your smartphone. In an embodiment, each advertisement automatically delivers additional exclusive content, discounts and rewards direct to your phone while you are watching.

For the consumer, Tickle™ will make advertising entertaining, exciting and rewarding. In turn, this will create better relationships, sales and ROI for brands while our unique method of delivery ensures that publishers across all verticals can continue to monetize (and in fact have the opportunity to significantly increase their levels of monetization due to the increased consumer engagement) without upsetting their consumers.

The overarching innovation is one cloud platform that enables the deep embedding of brand content across ALL media verticals triggered by specific consumer actions and decisions and centralized into one cloud platform allowing any consumer with the Tickle™ app or online browser to trigger and unlock additional content to then engage with further either immediately or at a later date often ending in the delivery and redemption of real-world rewards and offers.

In an embodiment, the aim of the platform is to give control to the end consumer over how they choose to engage with brands. Successful execution of such interactions changes the way that an Tickle™ user utilizes ads and content as they will potentially be able to uncover and win content from the 5,000-10,000 ads that we are subjected to each day. The Tickle™ platform creates for the user an exciting and novel way of unlocking content and rewards controlled by the user and their brand preferences and interests.

The Tickle™ cloud collates data from all sources across the brand and publisher content as well as the data stored by Tickle™ relevant to each consumer. The Tickle™ platform uses predetermined selection criteria from all sides and machine learning genetic algorithms to match the correct content to the correct end user. The application of computational logic then ensures that the established match is represented in real life through the delivery of the brand content for insertion or addition to the publisher content for the targeted audience to engage with should they so choose.

The Tickle™ application provides users with the ability to save ads and brand content for later use by the consumer in the Tickle™ application. The Tickle™ application may provide the ability to manage the ads selected and saved by the consumer through to conversion for brands and partners. The application presents the user with the confidence of remaining in a viewing or interactive experience upon clicking or swiping an ad within the experience. The system removes the negative connotation of clicking on an ad within an experience by saving an Tickle™ ad presented to the user during an experience in an electronic storage system on behalf of a user to permit the user to save the Tickle™ ad for action at a later time. Upon terminating an experience, the user may retrieve the saved ad for action at the user's convenience from the Tickle™ application and cloud. The ability to save the ad/content for later engagement and remain in the publisher experience is a key, novel feature of the Tickle™ system.

The Tickle™ system presents users with Tickle™ ads that are clickable during an experience, whether that experience is reading, playing a game, reviewing video content, immersive AR or VR actions, or any other virtual or online experience. The Tickle™ system embeds rewarding advertising or other content into the experience that permits the management of that ad or content without removing the user from the experience.

The Tickle™ system also provides more entertaining advertising/content by using such ads or content as gateways or trigger-points for Augmented Reality/Virtual Reality/Mixed Reality experiences. These experiences may be presented to a user either with or without attaching rewarding content to the experience.

The Tickle™ system also centralizes advertising from all existing and new advertising formats into the Tickle™ platform. This action empowers the entire advertising ecosystem to drive personal connections to the system that may translate into customer loyalty.

The following section describes how each mechanic, collectively the Tickle™ SDK and Tickle™ cloud platform, enable operators across the different applications for each vertical the end result is always the same; deep brand content, which may include metatdata and other content, is unlocked from the publisher content and delivered to the consumers Tickle™ app and online browser extension via the Tickle™ cloud for further engagement, experiences and reward redemption.

In an embodiment, the system process may be activated through the Tickle™+SDK for mobile and smartphone publishers. The following steps form the process:
a. Tickle™+ad units—presented as any form of mobile ad unit, the first time a consumer clicks on a unit (if they do not have the Tickle™ app) they will be prompted to enter their contact details where they will be sent a deep link to download the app from the app store. If the consumer already has the Tickle™ app running on their smartphone clicking on the publisher content will recognize this and trigger the brand content to automatically be stored in the Tickle™ app. Additionally, the Tickle™ cloud may receive and attach secondary data, such as metadata and other content, that is attached to and associated with each trigger of the Tickle™ app. The user will receive a notification to make them aware of this and they will carry on in the publisher app without having to leave. The consumer can then return to the Tickle™ app at a later date to engage further with the content they triggered.
b. Existing ad units—This is the same as the above however the ad units will be filtered through the Tickle™ SDK either at the publisher level directly or by the advertising agency who is supplying the advertising units to the publisher.
c. IntARactive Billboards—This is an entirely new form of advertising unit specifically for smartphone and applications that use maps as part of their product. Once a user opens the application with a map the Tickle™ SDK will trigger a digital billboard that will sit on the map. The user can choose to click on the billboard to engage further with the publisher content and then save any brand content (rewards, offers, content, metadata, and other collected information) to the Tickle™ app with one touch. They can then continue with what they were doing or choose to engage with the next publisher content that is presented to them via the Tickle™ billboard.

In an embodiment, the system process may be activated through the Tickle™+SDK for online websites (desktop and mobile). The following steps form the process:
a. Online website Tickle™+ad units—Proprietary ad units supplied and fulfilled by Tickle™. These can be conventional online advertising units or online content that when clicked on by the consumer saves the relevant brand content and associated metadata to the Tickle™ cloud keeping them on the publisher page provided the online Tickle™ browser extension is downloaded and active. If the Tickle™ browser extension is not present then on first click of an Tickle™ ad unit the user will prompted to download from the browser app store. Any brand content, such as, in a non-limiting example, ad content, ad metadata, and other content information, saved will be accessible to engage with later as per the Tickle™ model and can be accessed both online through the Tickle™ browser extension and on the users Tickle™ smartphone app.
b. Existing online ad units—This is the same as the above however the ad units will be filtered through the Tickle™+SDK either at the publisher level directly or by the advertising agency who is supplying the advertising units to the publisher.
c. Tickle™ browser extension—downloaded by the consumer ahead of time from the relevant browser store (i.e., Chrome, Firefox, Safari), the Tickle™ browser extension automatically identifies when a consumer is on an Tickle™ partner website where there is the opportunity to redeem an offer the consumer has stored in the Tickle™ cloud. The consumer is notified and they can then choose to allow the extension to automatically populate the offer into the discount code section of the website upon payment. The consumer will also be notified if there are offers available through the Tickle™ network should they wish to find them first before completing the process.

In an embodiment, the system process may be activated through the Tickle™+SDK for deep brand content embedded with the Tickle™+SDK and triggered by adSound™ technology for audio and video publishers. The following steps form the process:
a. Digital Out of Home Billboards—Connected (online) billboards will be able to play the encrypted adSound technology through their billboards to deliver content including, but not limited to, brand content related to the advertising unit on the billboard to a consumer's Tickle™ smartphone app.
b. TV live broadcast—The broadcast publishers will be able to layer adSound in their live broadcast audio to play the encrypted adSound technology through their live broadcast to deliver brand content related to the publisher content on the viewers screen at home to a consumer's Tickle™ smartphone app. This allows consumers to immediately engage with the ads and content they see in front of them on their TV with all content being saved to their Tickle™ app for immediate or later engagement. Imagine watching a live sport event and being able to receive offers related to billboards around the pitch, the kit your favorite team is wearing or the ads in the breaks.
c. TV broadcast—as above for pre-scheduled television viewing. The power for the brands and publishers here is for the first time ever knowing exactly who is sitting at home watching their show and ads.
d. TV video streaming—adSound™ can also be retrofitted to any streamed content library enabling consumers to engage with publisher content in an entirely new way by triggering deep brand content from within.
e. Smart speakers, radio and audio—This is the same mechanic as TV and Video broadcast although over radio, smart speakers and audio
f. Tickle™ Dome iBeacon—the Tickle™ iBeacon has been developed to allow for an extra layer of consumer security. Should they not wish to have the mobile device microphone access turned on indefinitely they can opt to have it turned on by an Tickle™ ‘Dome’ iBeacon when they come in to close proximity to the publisher content. The iBeacon can be used both at home and outdoors. An example would be to keep it in your home so when you are watching television, streaming video, gaming or listening to your smart speaker you are able to pick up content through Tickle™ to make your experience more rewarding and then when you leave the proximity of your home it automatically shuts off for added security. You may then also walk by some digital billboards that trigger the receiver to deliver a branded offer as you walk past and then again it is turned off when you are out of range.

In an embodiment, the system process may be activated an Tickle™+Programmatic RTB Exchange Platform for adSound™. The following steps form the process: adSound technology can be used to identify exactly who is in front of the publisher content at any given time. Not only will we be the only company globally that can supply this data but the Tickle™+Programmatic Real-Time buying platform can be used to target those individuals with the appropriate content based on their opted in data, likes and behaviors within the Tickle™ network meaning that different Tickle™ users could be exposed to different sequence of content whether this is at home in front of their tv or outside engaging with the same digital billboards.

In an embodiment, deep brand content may be manually triggered by the consumer for broadcast TV and audio. In the absence of adSound technology publishers are also able to make brand content available within the Tickle™ app that a consumer is able to engage with at the time of viewing simply by searching within the app itself.

In an embodiment, the system may initiate the Tickle™+SDK for online and offline computer game consoles and games—For gaming, the Tickle™+SDK enables the embedding and interaction of brand content in a way that's never been done before. As brands start to focus on sponsoring games and advertising inside gaming worlds, Tickle™ enables that to go as step further just like in the real-world and mobile with the addition of an extension that enables brand content discovered in the gaming world to be saved automatically to the Tickle™ cloud. As a broadcast medium it can also use adSound technology to trigger data transfer to the consumers Tickle™ smartphone app.

In an embodiment, the instant innovation provides for image recognition technology for broadcast and print media. In this embodiment, consumers can scan images within print or broadcast media using their smartphone to trigger brand content directly onto their Tickle™ app provided they have it installed on their phone or mobile device.

### Tickle™ Cloud Data Model:

The Tickle™ cloud provides an electronic storage for all data in the Tickle™ cloud data model, connecting the Tickle™ mobile app, online web browser and Tickle™ cloud accessed through the user's device and the Tickle™ Cloud services. All data received and managed by the Tickle™ cloud is processed and stored in the Tickle™ cloud by the Tickle™ Cloud Services.

All data elements within the Tickle™ cloud are managed by one or more Tickle™ Servers which assign a unique secret key used to identify the Publisher to the Tickle™ cloud services. All users are identified by a user ID as used in the Publishers system for each content publisher's unique representation of the user.

The Tickle™ cloud creates a data model for publisher and user information and assigns a campaign ID to uniquely identify the campaign/game to which the user is connected. The Tickle™ cloud stores the time and data of the user's interaction with the

Tickle™ services. The Tickle™ cloud additionally stores the user's location, utilizing latitude and longitude of the device accessing the Tickle™^{cloud} service, to position campaign and game assets. The Tickle™ cloud stores a list of channels the user has given consent to Tickle™ services to use, and the user's list of preferences for Brands to interact with through Tickle™ app.

In compliance with GDPR regulations the Tickle™ cloud Services may perform one or more GDPR checks to insure the data elements stored are properly permitted to be retained. The Tickle™ cloud stores the Users unique ID in the Publishers system, which will let Tickle™ cloud services create a unique ID when the User is new to Tickle™ services, or mapped to an existing Tickle™ ID for returning users.

The Tickle™ cloud services manages the state of the campaign to ensure that it is active and links the ID of the users Tickle™ ID if already associated to the current Campaign and User ID. Tickle™ cloud services requests and stores the Publishers verification of this User and wallet as eligible to be used for this particular Campaign. The Tickle™ cloud services maintains and tracks the user's list of Brands, Offers and Campaigns the user has given consent to interact with through the Tickle™ app storing this information and all associated metadata in the data model associated with the user, publisher, and campaign.

The instant innovation presents mobile and smartphone applications and websites, as well as data flows to the application and via beacon where applicable, and presents desktop websites and data flows to app and via beacon and browser extension where applicable. The instant innovation further presents print media and data flows to the application and via beacon where applicable. The instant innovation presents television and audio-visual broadcast and data flows to the application and via beacon where applicable, and digital and non-digital display advertising and data flows to the application and via beacon where applicable.

The instant innovation further integrates smart speakers and digital and analogue audio broadcast and data flows to the application and via beacon where applicable; it also integrates the Tickle™ mobile app, online browser extension, and Tickle™ cloud. The instant innovation presents ibeacon technology and one or more developer software interface loaded on to the user mobile phone or smart phone. A third-party authentication service is used to validate user's login and hold personal data. The instant innovation uses one or more phone data network used to connect users to the Tickle™ service with low latency and high speed. In a non-limiting embodiment said one or more phone data network may be characterized as 3G, 4G, 5G, LTE, WiFi, and/or as yet undeveloped air communication technology.

The instant innovation utilizes technology to drive data between computer servers to divide traffic and maintain service quality. One or more servers of the instant innovation are used to keep information on where users are in a campaign/game and a session; the instant innovation integrates long term storage of information such as publishers campaign data input from the Tickle™ admin console. One or more servers control the flow of the campaign/game and user interaction; one or more servers control the flow of the campaign/game and user interaction. The instant innovation maintains a queue of actions to be taken by the set of job servers controlling all actions in the game and/or campaign. The software of the instant innovation is operative to push all messages to users on their devices, regardless of whether the user is currently within the Tickle™ application. The instant innovation presents one or more servers that will handle incoming events that control the main functions of the campaign and/or game. The instant innovation includes a main database server or servers that store all information for the campaign and/or game including some personal data. Short term fast storage of temporary information to speed up response from the main database may be included in the instant innovation. The instant innovation may provide for one or more software extensions to the user's web browser and/or an external service to buy and sell advertising in the campaign and/or game. The instant innovation may include one or more Cloud providers service holding all software and services for Tickle™.

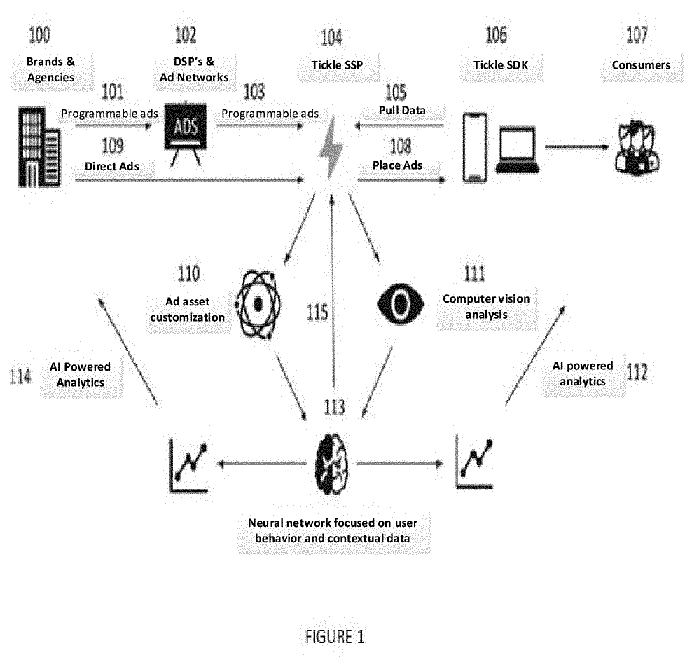

Turning now to FIG. 1, this figure presents a view of the centralized platform and SDK for all ad channels on Tickle™ Wallet consistent with certain embodiments of the present invention. In an exemplary embodiment, the figure presents cloud software that enables an end user to automatically or manually trigger brand content from any publisher content published across any visual or audio medium allowing the end user to save the content in on a centralized platform for later engagement and manual or automated redemption of real-world or digital goods and products.

Element 100 is representative of Third-party brands and agencies supplying brand content to the marketplace. Element 101 presents programmatic brand advertisement and content formatting. Element 102 presents the demand side platforms and advertising networks for the management of brand content. Element 103 presents the Programmatic brand advert and content format released from DSPs and ad networks ready for placement in publisher content. Element 104 presents the Tickle™ cloud and Supply Side Platform that matches the brand content to the publisher partner. Element 105 presents the Tickle™ SSP pulling the data from the publisher platform to match content with the publisher audience data. Element 106 is representative of any publisher of brand content and ads. Element 107 is representative of the publisher consumer audience. Element 108 presents the placement of brand content into the publisher platform. Element 109 presents brand content from being placed directly into the Tickle™ SSP via the brand portal.

Element 110 presents the brand content being customized for both the publisher platform and publisher audience based on the data collected and analyzed from both sources. Element 111 presents using a computer vision mechanic to analyze the publisher platform format to supply the correct brand content for an optimized experience for the publisher audience. Element 112 presents the Artificial Intelligence/Machine Learning technology for the analysis of audience data. Element 113 presents the Artificial Intelligence/Machine Learning technology used to match the brand and publisher data sources. Element 114 presents the Artificial Intelligence/Machine Learning algorithm for the analysis of brand content data. Element 115 presents the Artificial Intelligence/Machine Learning technology for the analysis of brand content data being returned to the exchange to inform the real-time matching process.

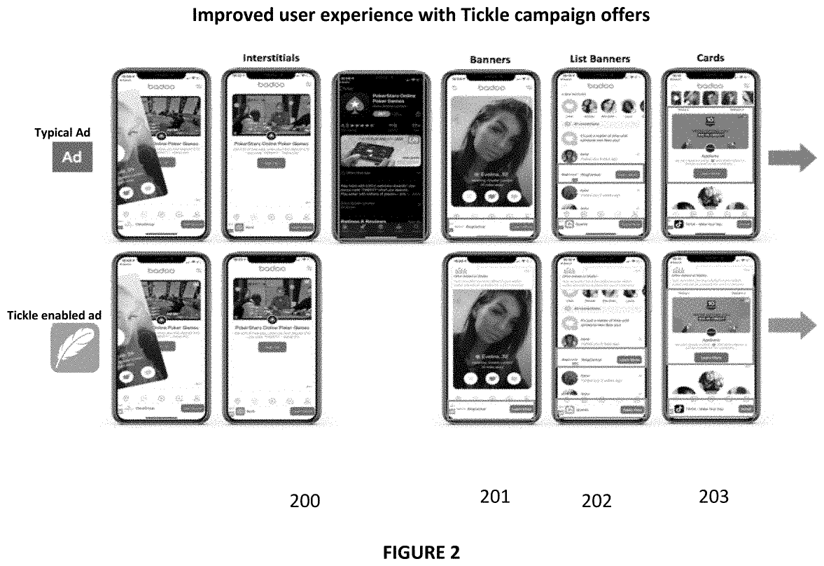

Turning now to FIG. 2, this figure presents a view of a state diagram for the Tickle™+SDK for mobile publishers, existing ad units, and Tickle™ proprietary ad units consistent with certain embodiments of the present invention. In an exemplary embodiment, the system presents a state diagram presenting the Tickle™+SDK for mobile publishers, showing existing ad units and Tickle™ proprietary ad units.

In this figure Element 200 presents the delivery of one or more interstitial mobile advertisement that when clicked on delivers brand content/offers/rewards/prizes to the Tickle™ wallet via Tickle™ cloud service allowing the user to remain in the publishing application. Element 201 presents the delivery of Native mobile advertisement in content feeds that when clicked on delivers brand content/offers/rewards/prizes to the Tickle™ wallet via Tickle™ cloud service allowing the user to remain in the publishing application. Element 202 presents the delivery of banner mobile advertisement that when clicked on delivers brand content, offers, rewards, and/or prizes to the Tickle™ wallet via Tickle™ cloud service allowing the user to remain in the publishing application. Element 203 presents the delivery of embedded card mobile advertisement that when clicked on delivers brand content/offers/rewards/prizes to the Tickle™ wallet via Tickle™ cloud service allowing the user to remain in the publishing application.

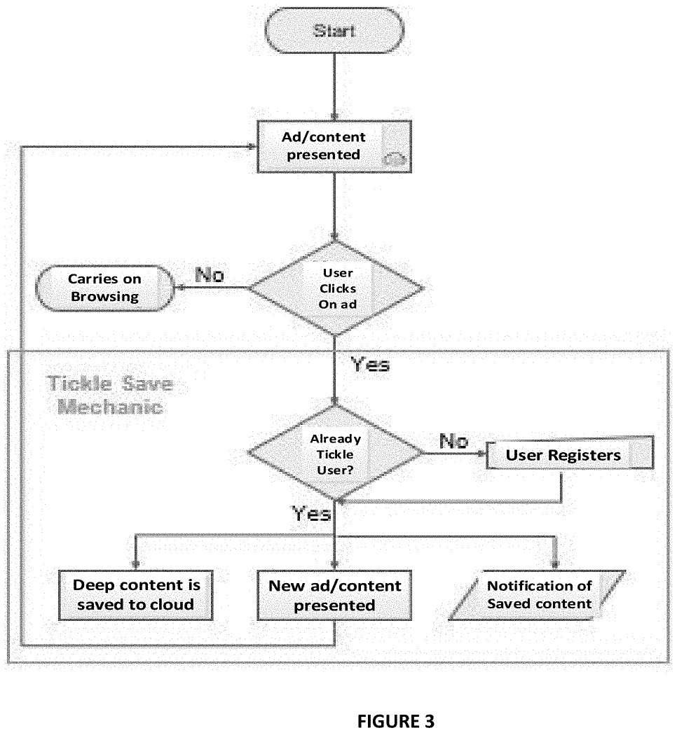

Turning now to FIG. 3, this figure presents a view of an SDK for embedding deep content in publisher content consistent with certain embodiments of the present invention. In an exemplary embodiment, this figure presents an SDK for embedding deep content in publisher content, inclusive of ad content, user and ad metadata, publisher data, and other data associated with the publisher content, where the publisher content is refreshed every time the end user engages with the publisher content to expose new content.

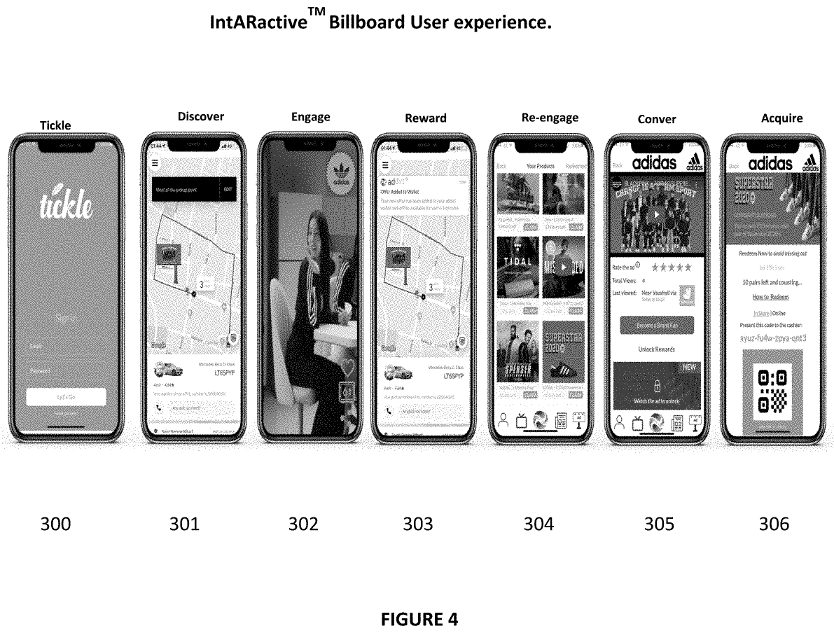

Turning now to FIG. 4, this figure presents a view of a state diagram for the Tickle™+SDK for the delivery of IntARactive™ billboards on map-based apps and websites consistent with certain embodiments of the present invention. In an exemplary embodiment, this figure presents an SDK for the creation and deployment of targeted and non-targeted “in-world” digital billboards on map-based product users may engage within the same manner as previously described methods.

In this embodiment, element 300 presents the Tickle™ mobile application interface view. Element 301 presents the delivery of digital mobile advertisement on a map that when clicked on delivers brand content/offers/rewards/prizes to the Tickle™ wallet via Tickle™ cloud service allowing the user to remain in the publishing application. Element 302 presents the delivery of promotional material and/or augmented reality and/or mixed reality experience triggered by the user engaging with the content on the map 301. Element 303 presents the Tickle™ technology allowing the user to remain in the publisher application with a notification to show the brand content attached to the advert/brand content 301 and 302 being saved to the Tickle™ cloud and accessible through the Tickle™ app 300. Element 304 presents the Tickle™ app showing brand content that has been collected by the user through the various advertising mediums FIG. 1. Element 305 presents the consumer-facing merchant page within the Tickle™ application used by brand partners to deliver content and set game and competition rules. Element 306 presents the unlocking of a digital reward collected through the advertising mediums FIG. 1 presenting the user with a unique code for redemption either online or offline.

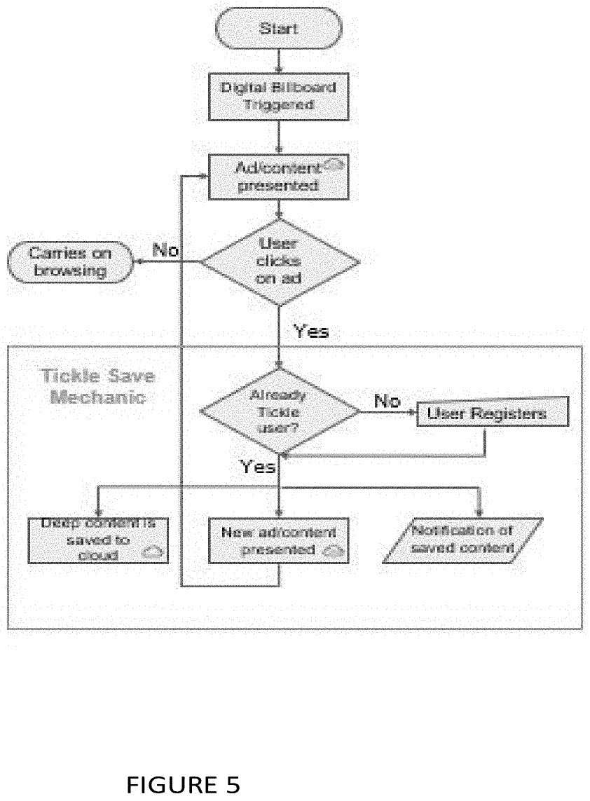

Turning now to FIG. 5, this figure presents a view of the process of utilizing an SDK for embedding in-world digital billboards within publisher maps and digital worlds consistent with certain embodiments of the present invention.

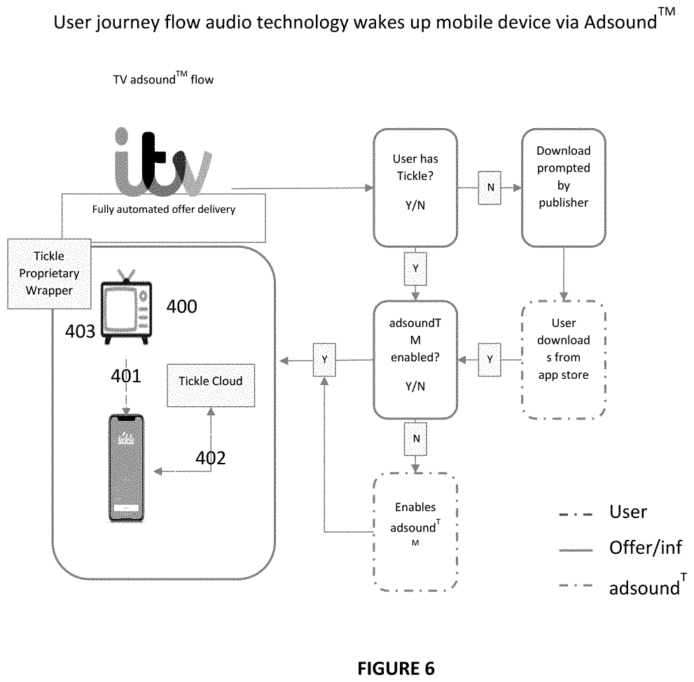

Turning now to FIG. 6, this figure presents a view of embedding encrypted sound technology in broadcast media consistent with certain embodiments of the present invention. The embedding of encrypted sound technology in broadcast media may deliver targeted and non-targeted content to an end user's device based upon the end user's proximity to the broadcast medium that may then be used to redeem real-world or digital goods or products. In this embodiment, element 400 presents the visual/audio broadcast publishing partner.

Element 401 presents the Tickle™ adSound™ audio technology being played simultaneously with the content from the publisher 400 after being embedded by the publisher and the adSound™ audio tech is being received by the user's smartphone that subsequently awakes the Tickle™ app that is running in the background. Element 402 presents the encrypted code within the adSound™ audio 401 identifies the brand content being published 400 and delivers the related brand content from the Tickle™ cloud to the Tickle™ mobile application. Element 403 presents the Tickle™ SDK that is embedded within the publisher content by way of the Tickle™ adSound™ audio technology.

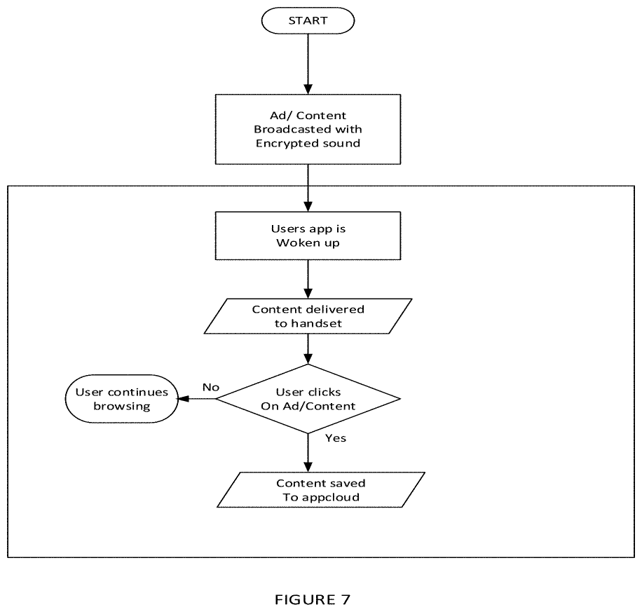

Turning now to FIG. 7, this figure presents a view of an SDK for embedding brand content within broadcaster content consistent with certain embodiments of the present invention. This figure presents the adSound™ process of utilizing an SDK for embedding brand content within broadcaster content with automatic delivery to a user handset using encrypted sound technology.

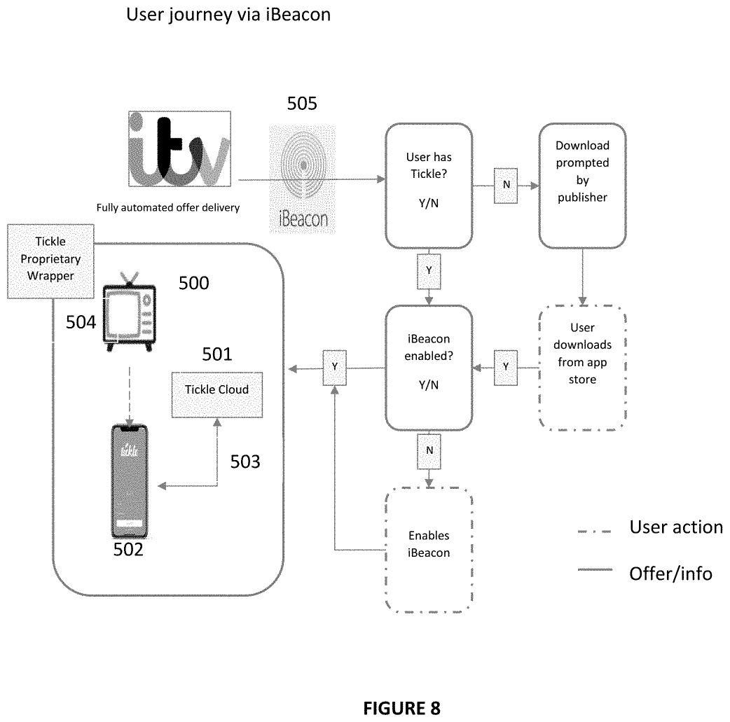

Turning now to FIG. 8, this figure presents a view of the use of iBeacon and/or Bluetooth technology to activate and deactivate a consumer's device consistent with certain embodiments of the present invention.

In an embodiment, element 500 presents the visual/audio broadcast publishing partner. Element 501 presents the Tickle™ cloud services available to a user. Element 502 presents the Tickle™ adSound™ audio technology being played simultaneously with the content from the publisher after being embedded by the publisher and the adSound™ audio tech is being received by the user's smartphone that subsequently awakes the Tickle™ app that is running in the background. Element 503 presents the encrypted code within the adSound™ audio, identifies the brand content being published, and delivers the related brand content from the Tickle™ cloud to the Tickle™ mobile application. Element 504 presents the Tickle™ SDK that is embedded within the publisher content delivering the Tickle™ adSound™ audio technology. Element 505 presents the Beacon that triggers the listening mechanic in the user's smartphone/mobile device when in proximity. Once triggered, adSound™ is able to speak to the Tickle™ app to enable interacting and delivery of Tickle™ content. When the user leaves the proximity adSound™ is no longer connected to the user's audio device and may not deliver sound content.

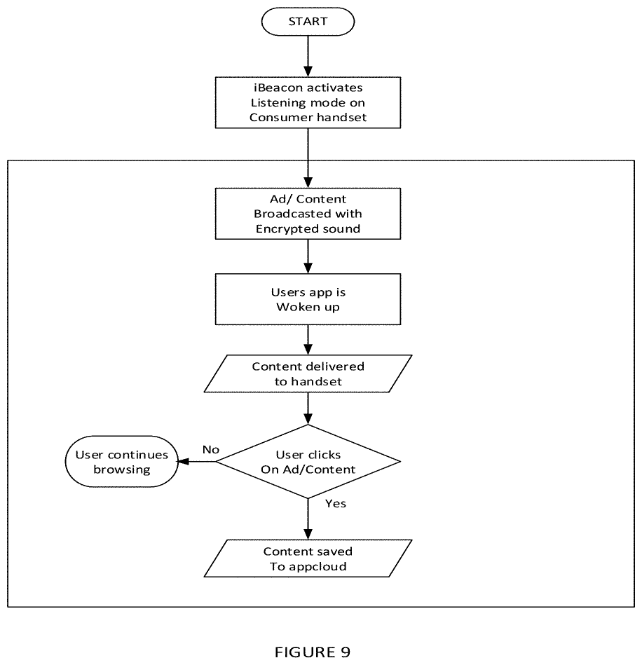

Turning now to FIG. 9, this figure presents a view of an SDK for embedding brand content within broadcaster content with automatic delivery to a user handset consistent with certain embodiments of the present invention. This figure presents the adSound™ process of utilizing an SDK for embedding brand content within broadcaster content with automatic delivery to user handset, including activation of the handset microphone using iBeacon technology.

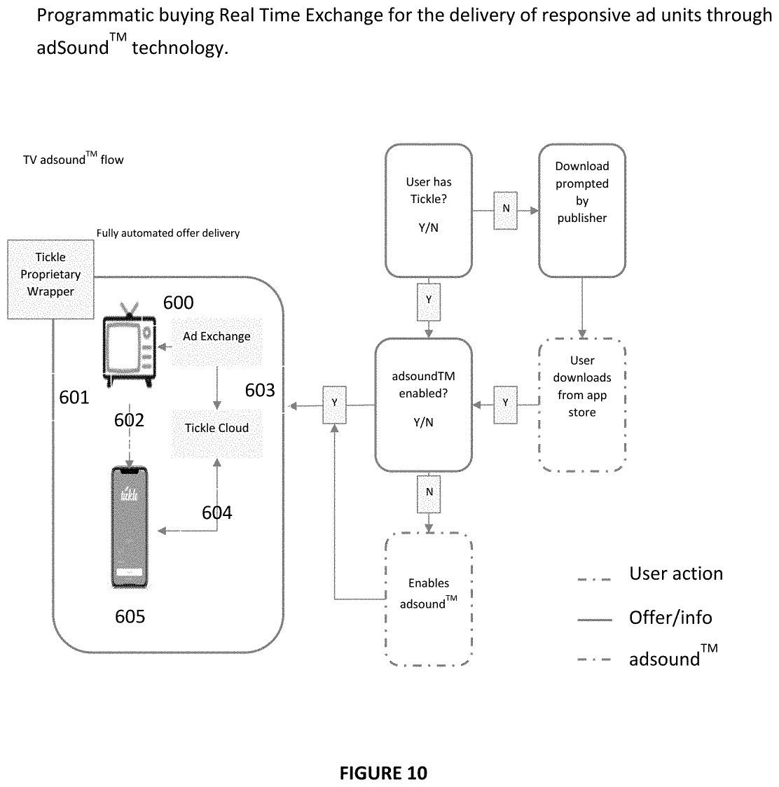

Turning now to FIG. 10, this figure presents a view of the programmatic real-time exchange for the delivery of brand advertising and content through adSound™ technology consistent with certain embodiments of the present invention. In an embodiment this figure presents the creation and execution of a programmatic Real-Time Buying platform and technology that can receive data from a consumer's device that is in close proximity to a broadcast medium and then matches the consumer data received to enable the serving/broadcasting of targeted adverts and/or content on the broadcast medium based on the audience.

In this figure, element 600 presents the visual/audio broadcast publishing partner. Element 601 presents the Tickle™ SDK that is embedded within the publisher content delivering the Tickle™ adSound™ audio technology. Element 602 presents the Tickle™ adSound™ audio technology being played simultaneously with the content from the publisher after being embedded by the publisher and the adSound™ audio tech is being received by the user's smartphone that subsequently awakes the Tickle™ app that is running in the background. Element 603 presents the Tickle™ ad exchange facilitates the real time fulfillment of the supply and demand of the brand content based on matching the end user data from the Tickle™ cloud and the predetermined parameters set for targeting by the brand, where all fulfillment is delivered in real-time. Element 604 presents publication of the delivery of brand content once the brand content is matched to the end user and published through the publisher partner. The encrypted code within the adSound™ audio identifies the brand content being published and delivers the related brand content from the Tickle™ cloud to the Tickle™ mobile application.

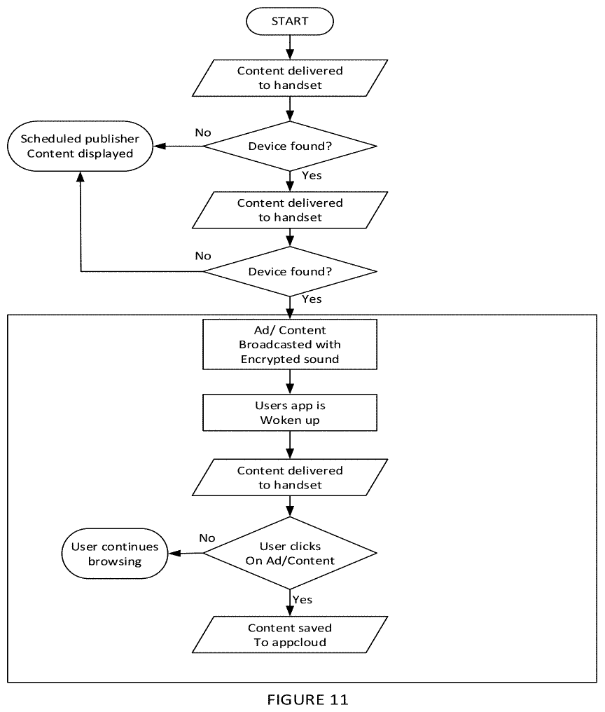

Turning now to FIG. 11, this figure presents a view of programmatic real-time buying for delivering targeted publisher content using encrypted sound technology to trigger targeted brand content delivery consistent with certain embodiments of the present invention. This figure presents the adSound™ process of programmatic real-time buying for delivering targeted publisher content using encrypted sound technology to trigger targeted brand content that is delivered automatically to the end user.

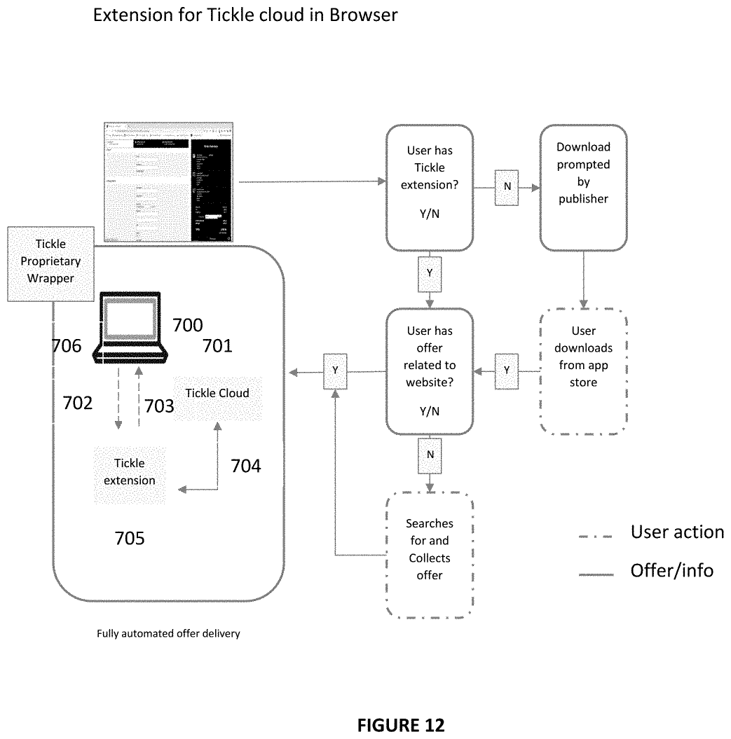

Turning now to FIG. 12, this figure presents a view of a state diagram showing browser extension for Tickle™ Wallet in a browser consistent with certain embodiments of the present invention. This embodiment presents an online Tickle™ Wallet browser extension connected to the cloud that automatically searches a connected user's data to match brand content to the website the user is viewing and matches and populates related offers, discounts, vouchers, and rewards that may be available to the user.

In this figure, element 700 presents any online website. Element 701 presents the Tickle™ Cloud. Element 702 presents a website triggering the Tickle™ browser extension to search within the Tickle™ cloud for existing brand content to fulfill offers, discounts, and rewards that may be available to the user. Element 703 the Tickle™ browser extension returning information to the website to populate the brand content resulting from a positive search result. Element 704 presents the Tickle™ extension connecting to the Tickle™ cloud to search and retrieve content for population on the website. Element 705 presents the Tickle™ online browser extension, and element 706 presents the Tickle™ SDK.

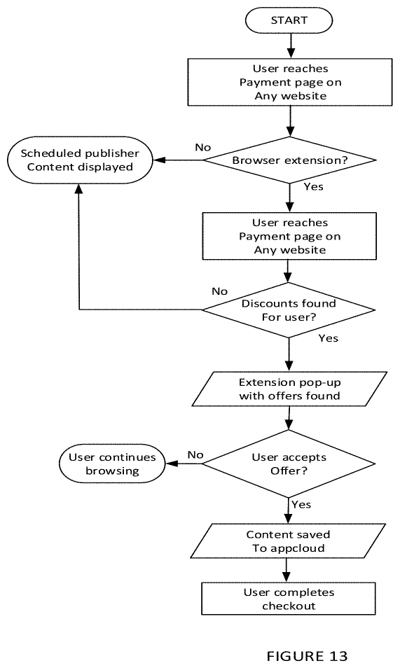

Turning now to FIG. 13, this figure presents a view of the delivery of brand content from interactions within a virtual world for engagement and redemption by an end user consistent with certain embodiments of the present invention. This figure presents an SDK for the delivery of brand content from interactions within a virtual world to a cloud database for engagement and redemption by the end user in the real world via an online web browser extension, plug-in, or software application.

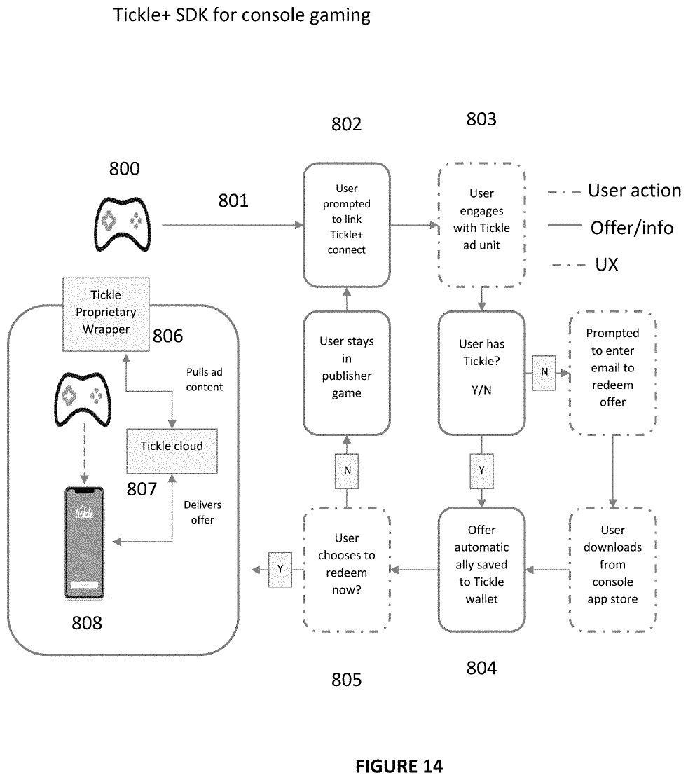

Turning now to FIG. 14, this figure presents a view of connection of the Tickle™ SDK and a gaming console medium for the delivery of brand content to a user consistent with certain embodiments of the present invention. This embodiment presents an SDK for the delivery of brand content from interactions within a virtual world to a cloud database for engagement and redemption by the end user in the real world via an online web browser extension, plug-in, or software application. In a non-limiting example, a computer game and gaming console may be connected to the Tickle™ SDK for delivery of brand content into a game or games being experienced by a consumer.

In this figure, element 800 presents a computer console platform and games installed within the computer console platform. Element 801 presents the user experiencing a game on the game console. Element 802 presents the user action in installing the Tickle™ extension onto the game console. Element 803 presents the users decision, once exposed to brand content, to engage with the advertising unit. In an embodiment, if an in-world impression requires no interaction, the content is automatically sent to the Tickle™ cloud. Element 804 presents the user saving the triggered content to the Tickle™ cloud to be retrieved by the Tickle™ app or online browser. Element 805 presents the user choosing to open the Tickle™ application and engage with the delivered brand content in the Tickle™ app. Element 806 presents the Tickle™ SDK that is contained within the console platform or game to enable the layering and triggering of brand content triggered by the end user. Element 807 presents the Tickle™ cloud and element 808 presents the Tickle™ application where the triggered content can be retrieved and with which the user may engage.

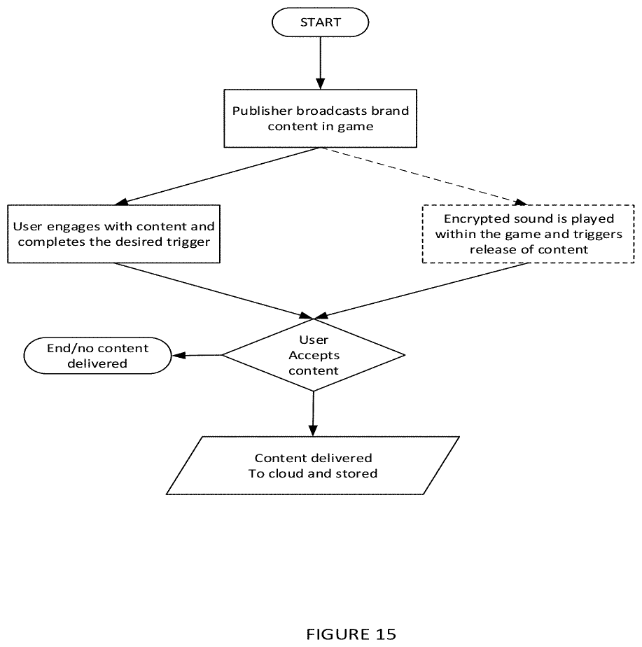

Turning now to FIG. 15, this figure presents a view of the publication of game publisher generated brand content within a game consistent with certain embodiments of the present invention. This figure presents an SDK for the delivery of brand content from interactions within a virtual world to a cloud database for engagement and redemption by the end user in the real world via an online web browser extension, plug-in, or software application. In a non-limiting example, the user may have installed the Tickle™ mobile application and online browser extension or game console extension installed on their game console or computer system. Game publishers may publish brand content within a game or application on the game console or computer system. The SDK enables further content from brand assets to be unlocked by the user during interaction with the game or computer application.

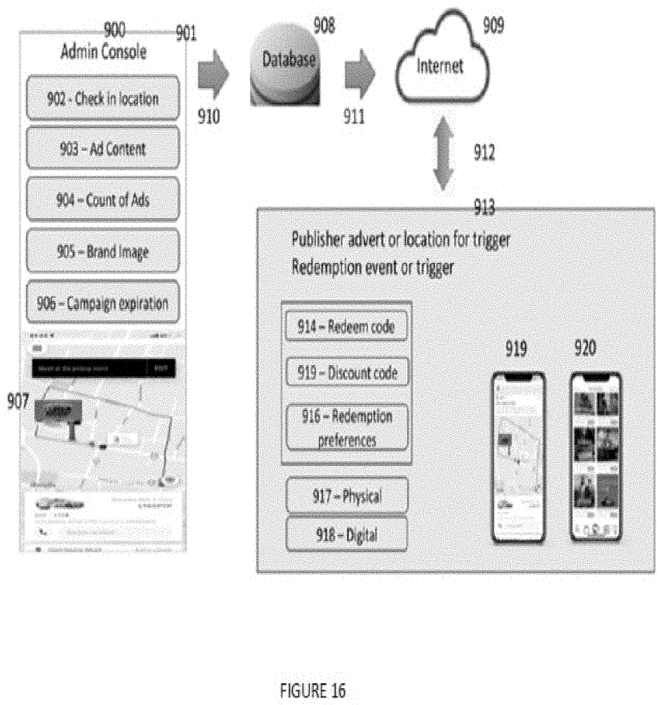

Turning now to FIG. 16, this figure presents a view of generation of an advertising campaign into an Tickle™ domain consistent with certain embodiments of the present invention. This figure presents an advertising campaign being placed within the Tickle™ domain.

In this figure, element 900 presents the brand administrator interface console for access to a campaign or game. Element 901 presents the visual representation of actions available to a brand administrator. Element 902 presents an action to define a “check in location” for a user in the campaign or game. Element 903 presents an action to define ad content for the campaign or game. Element 904 presents an action to count ads for the campaign or game. Element 905 presents an action to define a brand image for the campaign or game. Element 906 presents an action to define expiration criteria for the campaign or game. Element 907 presents a publisher interface map displaying an accurate real-world digital map, and the selected check-in locations from where the campaign assets will be located in the augmented reality environment. Element 908 presents the cloud services database for all campaign data. Element 909 presents the Internet connection linking cloud services and the user's device. Element 910 presents the communications channel between the administrator console and the cloud services. Element 911 presents the communications channel between the cloud services and the Internet. Element 912 presents the communications channel between the Internet and the user's device. Element 913 presents the mechanism to trigger events on the user's device. Element 914 presents an action to redeem a code for the user. Element 915 presents an action to use a discount code for the user. Element 916 presents the user's preferences for redemption. Element 917 presents users' action to redeem a physical object. Element 918 presents the user's action to redeem a digital representation of the object. Element 919 presents a device screen showing a map interface to the campaign or game. Element 920 presents a device screen showing a visual representation of objects for redemption by the campaign or game.

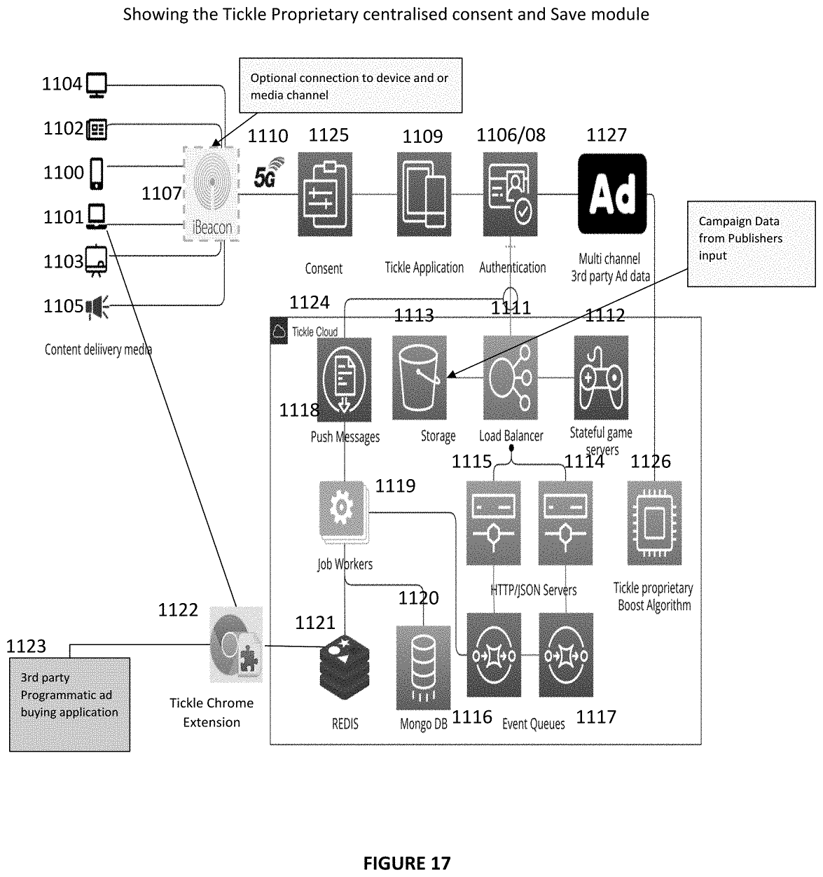

Turning now to FIG. 17, the centralized consent management module where consumer opt-in happens in the Tickle™ app, enabling Tickle™ to collect data and serve content to the consumer in a third-party environment consistent with certain embodiments of the present invention is shown. The instant innovation provides for a centralized consent management module where the Tickle™ user is able to ‘opt-in’ to tracking and further marketing and advertising communication from the Tickle™ service provider both in the Tickle™ app and in any of the Tickle™service provider's third-party partners apps/web/site/publishers where there is Tickle™ technology providing the content. This means that Tickle™ users can pick and choose the ads and content that are shown to them in any of the Tickle™ partner environments. Users may ‘boost’ the offer that the Tickle™ technology delivers to the user as part of the act of ‘saving the ad/content’. By way of non-limiting example, the user may be in a publisher app and may swipe an advert from a brand to ‘save for later’. Tickle™ may match that content to an associated offer and deliver the offer to the user in the Tickle™ app and/or website extension. The user may then be prompted to ‘boost the offer’ by completing one or more actions. Once the action is complete (in a non-limiting example, this action may be sharing the offer with friends or watching further content from the associated brand) the ‘% off’ offer may be boosted to a higher ‘% off’ offer that the Tickle™ technology has pulled from our own database or from online.

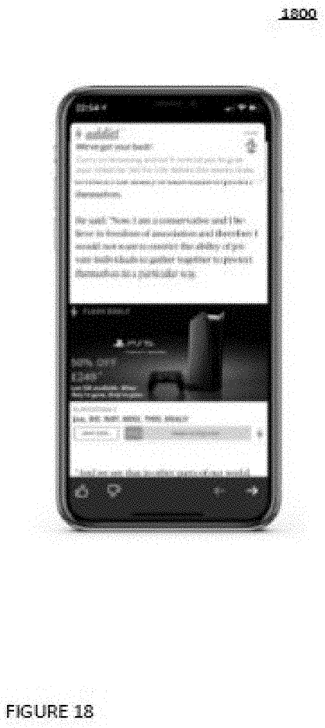

Turning now to FIG. 18, a first view of a user experience involving direct purchase of items consistent with certain embodiments of the present invention is shown. At 1800 an advertisement embedded within content is presented to the user. In an embodiment, the user may click on the advertisement and/or a hyperlink associated with the advertisement to learn more about the product and/or service being advertised and/or to initiate purchase of the product and/or service.

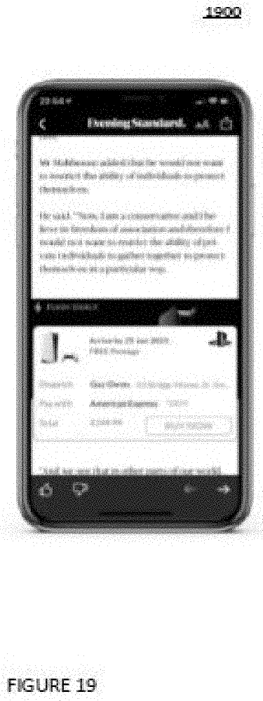

Turning now to FIG. 19, a second view of a user experience involving direct purchase of items consistent with certain embodiments of the present invention is shown. At 1900 is a purchase confirmation prompt seeking purchase confirmation from the user. In an embodiment, the purchase confirmation is displayed as a result of the user clicking on the advertisement as shown in FIG. 18 and after the instant innovation has pulled user payment data from the Cloud.

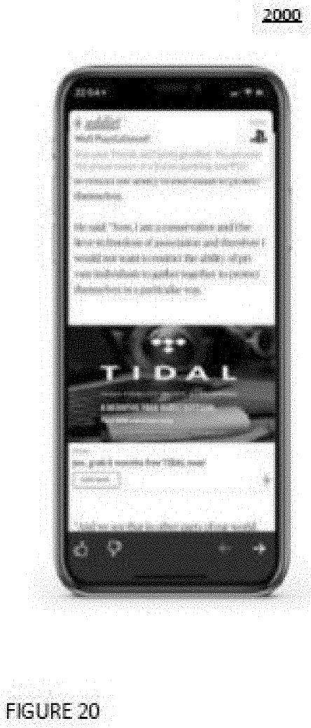

Turning now to FIG. 20, a third view of a user experience involving direct purchase of items consistent with certain embodiments of the present invention is shown. If at 1900 the user confirms a particular purchase, at 2000 the instant innovation displays a message informing the user that the purchase has been successfully completed. In an embodiment, new content is displayed once the purchase is confirmed or denied by the user.

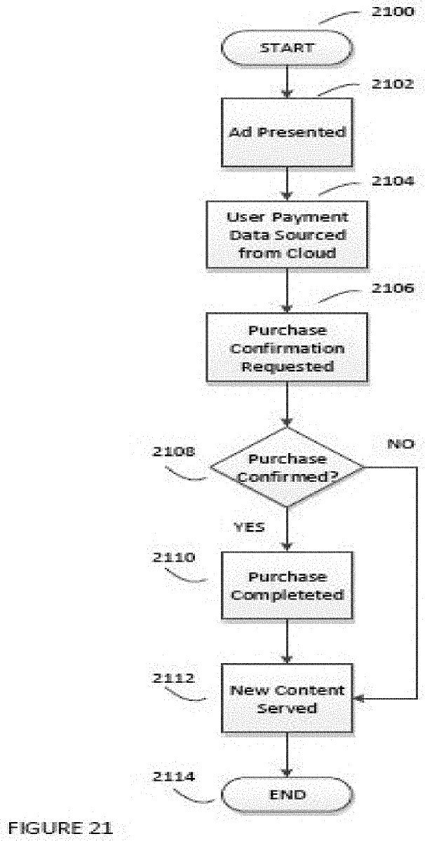

Turning now to FIG. 21, a process view of a sub-process involving direct purchase of items from ad units consistent with certain embodiments of the present invention is shown. At 2100 the sub-process starts. At 2102 the instant innovation presents a content-embedded advertisement to the user. At 2104 the instant innovation sources user payment data from a network of connected servers referred to herein as the “Cloud.” At 2106 the instant innovation displays a message requesting the user to confirm or deny a particular purchase. If at 2108 the user does not confirm the purchase, at 2112 the instant innovation serves new content to the user. If at 2108 the user confirms the purchase, at 2110 the instant innovation processes payment data and completes the purchase, and at 2112 the system serves new content to the user. At 2114 the sub-process ends.

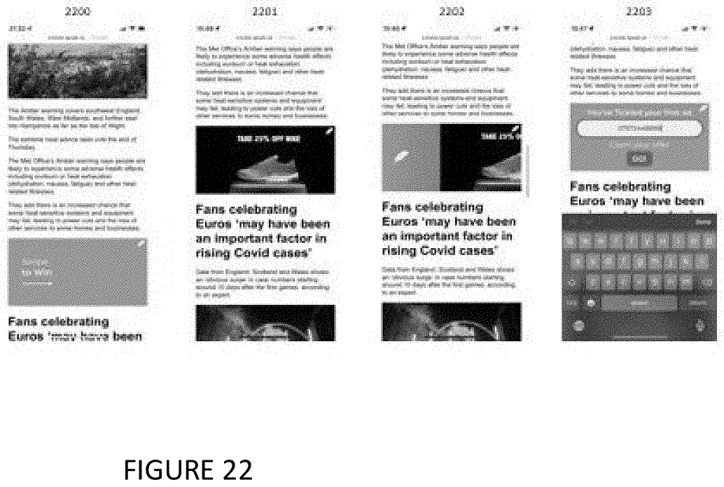

Turning now to FIG. 22, a view of the unique way that the advert or content identifies itself to the user as content that can be engaged with further consistent with certain embodiments of the present invention is shown. As the consumer scrolls up and down the page on a publisher app or web site (2200), in this instance, the advert has a colored cover on it which starts solid and opaque in nature with a call to action to engage with the ad as the content enters and leaves the screen and then dissipates to reveal the content for engagement as it reaches the consumers view (2201). Now identified as content that can be engaged with “Tickled”, the user can now take an action that triggers the ‘saving’ of the ad for later in the Tickle™ app (in this case by swiping the ad, 2202). The ad content itself may not actually be saved but we refer to this action in this way because the action taken by the consumer triggers the release of further content associated with the initial content and delivers it in the Tickle™ app. In this example the users ‘saves’ a 25% off offer from a brand and can then carry on in the publisher environment before going to the Tickle™ app to review the new content they have unlocked and to engage further at will. 2204 shows that action taken when a consumer Tickles an ad or content for the very first time; they are asked for their phone number which then enables the Tickle™ system to send a link to their phone to download the Tickle™ app.

While certain illustrative embodiments have been described, it is evident that many alternatives, modifications, permutations and variations will become apparent to those skilled in the art in light of the foregoing description.

We claim:

1. A system of embedding brand content, comprising:
one or more servers each having one or more processors in wired and/or wireless communication with one or more user devices;
said one or more servers operative to provide to the user one or more publisher content experiences;
a user interface associated with each of said one or more user devices;
a software module operative to analyze brand content data;
said software module centralizing said brand content data from all existing and new advertising formats into an aggregated advertising platform;
said software module presenting to a user content within any of an Augmented Reality and/or Virtual Reality and/or Mixed Reality experience while serving as a gateway for any of said Augmented Reality and/or Virtual Reality and/or Mixed Reality experiences;
said software module active to permit a user to interact with said aggregated advertising platform while remaining in said one or more publisher content experiences.

2. The system of claim 1, where the one or more user devices include smart phones, tablets, laptop computers, wearable computers and devices, and/or desktop computers.

3. The system of claim 1, where the wireless communication technology is 3G, 4G, 5G, LTE, WiFi, and/or as yet undeveloped over the air communication technology.

4. The system of claim 1, where the publisher content experience includes visual and/or audio media deliverable from a publisher to a user.

5. The system of claim 4, where said media deliverable includes reading material, game play, video content, immersive Augmented Reality and/or Virtual Reality and/or Mixed Reality actions, and/or any other virtual or online experience.

6. The system of claim 1, where the software module uses an algorithm to analyze brand content data.

7. The system of claim 1, where centralizing advertising from captured media content utilizes image recognition technology.

8. The system of claim 1, where the platform is operated by the system provider.

9. The system of claim 1, where said content serving as a gateway may be a trigger point for an Augmented Reality and/or Virtual Reality and/or Mixed Reality experience.

10. The system of claim 1, where the experiences are embedded with advertising, metadata associated with advertising, metadata associated with a user, publisher, or content provider, and/or other content.

11. A method of embedding brand content, comprising:
establishing communication between one or more servers and one or more user devices;
said one or more servers each having one or more processors in wired and/or wireless communication with one or more user devices;
providing to the user one or more publisher content experiences using a user interface associated with each said one or more user devices;
analyzing brand content data using a software module;
centralizing advertising from all existing and new advertising formats into an aggregated advertising platform;
said software module presenting to a user content within any of an Augmented Reality and/or Virtual Reality and/or Mixed Reality experience while serving as a gateway for any of said Augmented Reality and/or Virtual Reality and/or Mixed Reality experiences;
said software module active to permit a user to interact with said aggregated advertising platform while remaining in said one or more publisher content experiences.

12. The system of claim 11, where the one or more user devices include smart phones, tablets, laptop computers, wearable computers and devices, and/or desktop computers.

13. The system of claim 11, where the wireless communication technology is 3G, 4G, 5G, LTE, WiFi, and/or as yet undeveloped over the air communication technology.

14. The system of claim 11, where the publisher content experience includes visual and/or audio media deliverable from a publisher to a user.

15. The system of claim 14, where said media deliverable includes reading material, game play, video content, immersive Augmented Reality and/or Virtual Reality and/or Mixed Reality actions, and/or any other virtual or online experience.

16. The system of claim 11, where the software module uses an algorithm to analyze brand content data.

17. The system of claim 11, where centralizing advertising from captured media content utilizes image recognition technology

18. The system of claim 11, where the platform is operated by the system provider.

19. The system of claim 11, where the content serving as a gateway is a trigger point for an Augmented Reality and/or Virtual Reality and/or Mixed Reality experience.

20. The system of claim 11, where the experiences are embedded with advertising, metadata associated with advertising, metadata associated with a user, publisher, or content provider, and/or other content.
